(19) United States
(12) Patent Application Publication
(10) Pub. No.: US 2025/0081078 A1
(43) Pub. Date: Mar. 6, 2025

(54) Systems and Methods for Consent Information Delivery in Wireless Communications

(71) Applicant: APPLE INC., Cupertino, CA (US)

(72) Inventors: Alexander Sirotkin, Hod Hasharon (IL); Vivek G. Gupta, San Jose, CA (US); Shu Guo, Beijing (CN)

(21) Appl. No.: 18/726,491

(22) PCT Filed: Jan. 6, 2022
(86) PCT No.: PCT/CN2022/070515

§ 371 Date: Jul. 3, 2024

(51) Int. Cl. H04W 36/36; H04W 36/00; H04W 36/30; H04W 36/32; H04W 84/04

(52) U.S. Cl. CPC H04W 36/365; H04W 36/0033; H04W 36/305; H04W 36/322; H04W 84/042

(57) ABSTRACT

Apparatuses, systems, and methods for a framework for user consent delivery and utilization in cellular communication systems. An access and mobility management function (AMF) of a network may obtain, from a user data management (UDM), user consent information via a user consent parameter included in a structured data type. The AMF may provide, to a base station of the network, the user consent information via a user consent information element. The user consent information element may be associated with at least one data type and the at least one data type may include radio link failure (RLF) information sharing consent and/or user location information sharing consent. The user consent information element may be included in any of an initial context setup request message, a user equipment (UE) context modification request message, and/or a handover request message.

This application is a national phase entry of PCT application number PCT/CN2022/070515, entitled “Systems and Methods for Consent Information Delivery in Wireless Communications,” filed Jan. 6, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for user consent information delivery and utilization throughout a cellular network system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, CHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the robustness and accuracy of transmitted and received signals through user equipment (UE) devices, e.g., through wireless devices such as cellular phones, base stations and relay stations used in wireless cellular communications.

In some circumstances, a network (e.g., a base station of a network) may request that a UE provide location information (e.g., Global Navigation Satellite System (GNSS) based location) by including an indication to obtain the UE's location information in a radio resource control (RRC) parameter, such as in an RRCReconfiguration parameter. Once configured, the UE may provide available detailed location information in a measurement report, a radio link failure (RLF) report, and/or in a secondary cell group failure information parameter, such as an SCGFailureInformation parameter. However, there is some concern that in certain jurisdictions, an operator may be required to obtain user consent for location information sharing which is not allowed by current 3GPP specifications. Further, there ongoing work in standards development to define user consent requirements. Therefore, a framework for collecting user consent is needed.

### SUMMARY

Embodiments relate to wireless communications, and more particularly to apparatuses, systems, and methods for a framework for user consent delivery and utilization in cellular communication systems. Note that embodiments described herein are unrelated to collection of user consent for sharing various information, e.g., such as collection of user consent for sharing radio link failure information and/or user location information, which may be used by a network operator for various purposes, e.g., such as network optimization. In other words, embodiments described herein are related to sharing of user consent information within a cellular communication system (e.g., between various nodes and/or entities within and/or in communication with the cellular communication system) and are not related to collection of user consent information and/or collection of various information based on user consent information.

For example, in some embodiments, an access and mobility management function (AMF) of a network may obtain, from a user data management (UDM), user consent information via a user consent parameter included in a structured data type. The structured data type may be an AccessAndMobilitySubscriptionData. The user consent parameter may be associated with at least one data type and the at least one data type may include general user location sharing consent (e.g., via location sharing in a radio link failure (RLF) report and/or via location sharing in a connection establishment failure (CEF) report), RLF report information sharing consent, and/or CEF report information sharing consent. The AMF may provide, to a base station of the network, the user consent information via a user consent information element. The user consent information element may be associated with at least one data type and the at least one data type may include general user location sharing consent (e.g., via location sharing in a radio link failure (RLF) report and/or via location sharing in a connection establishment failure (CEF) report), RLF report information sharing consent, and/or CEF report information sharing consent. The user consent information element may be included in any of an initial context setup request message, a user equipment (UE) context modification request message, and/or a handover request message.

As another example, in some embodiments, a base station may receive, from an AMF of the network, user consent information via a user consent information element. The user consent information element may be included in any of an initial context setup request message, a user equipment (UE) context modification request message, and/or a handover request message in any of an initial context setup request message, a user equipment (UE) context modification request message, and/or a handover request message. The base station may provide, during a handover procedure, the user consent information via the user consent information element to a target base station. The user consent information element may be included in any of a handover request message and/or a retrieve UE context response message.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Tables, Figures, and Claims.

### BRIEF DESCRIPTION OF THE DRAWINGS

FIG. 1 illustrates an exemplary (and simplified) wireless communication system, according to some embodiments.

FIG. 2 illustrates an exemplary base station in communication with an exemplary wireless user equipment (UE) device, according to some embodiments.

FIG. 3 illustrates an exemplary block diagram of a UE, according to some embodiments.

FIG. 4 illustrates an exemplary block diagram of a base station, according to some embodiments.

FIG. 5 illustrates an example block diagram of a server according to some embodiments.

FIG. 6 illustrates a block diagram of an example of a method for delivery of user consent information within a network, according to some embodiments.

FIG. 7 illustrates a block diagram of another example of a method for delivery of user consent information within a network, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
BS: Base Station
DL: Downlink
UL: Uplink
LTE: Long Term Evolution
NR: New Radio
5GS: 5G System
5GMM: 5GS Mobility Management
5GC/5GCN: 5G Core Network
IE: Information Element
CE: Control Element
MAC: Medium Access Control
RRC: Radio Resource Control

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones, portable gaming devices, laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

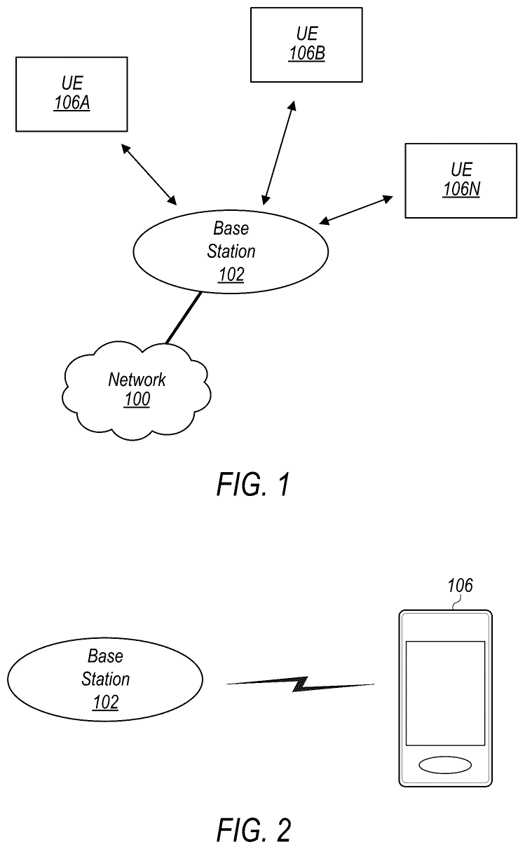

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, cHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using cither or both of a 3GPP cellular communication standard or a 3GPP2 cellular communication standard. The UE 106 may also be configured to be camped on and communicate with multiple base stations concurrently. In some embodiments, the UE 106 may be configured to a framework for user consent delivery and utilization in cellular communication systems, e.g., according to the various methods described herein. Note that embodiments described herein are unrelated to collection of user consent for sharing various information, e.g., such as collection of user consent for sharing radio link failure information and/or user location information, which may be used by a network operator for various purposes, e.g., such as network optimization. In other words, embodiments described herein are related to sharing of user consent information within a cellular communication system (e.g., between various nodes and/or entities within and/or in communication with the cellular communication system) and are not related to collection of user consent information and/or collection of various information based on user consent information. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

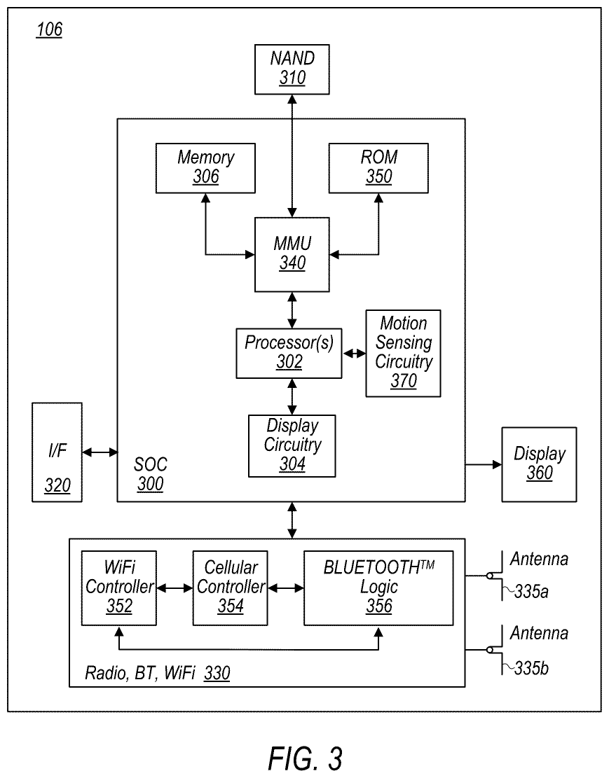

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash memory 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. As noted above, the UE may be configured to communicate wirelessly using multiple wireless communication standards in some embodiments.

The UE 106 may include hardware and software components for implementing a framework for user consent delivery and utilization in cellular communication systems, e.g., according to the various methods described herein. Note that embodiments described herein are unrelated to collection of user consent for sharing various information, e.g., such as collection of user consent for sharing radio link failure information and/or user location information, which may be used by a network operator for various purposes, e.g., such as network optimization. In other words, embodiments described herein are related to sharing of user consent information within a cellular communication system (e.g., between various nodes and/or entities within and/or in communication with the cellular communication system) and are not related to collection of user consent information and/or collection of various information based on user consent information. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to a framework for user consent delivery and utilization in cellular communication systems, e.g., according to the various methods described herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments may have fewer or more similar controllers for various different RATs that may be implemented in UE device 106.

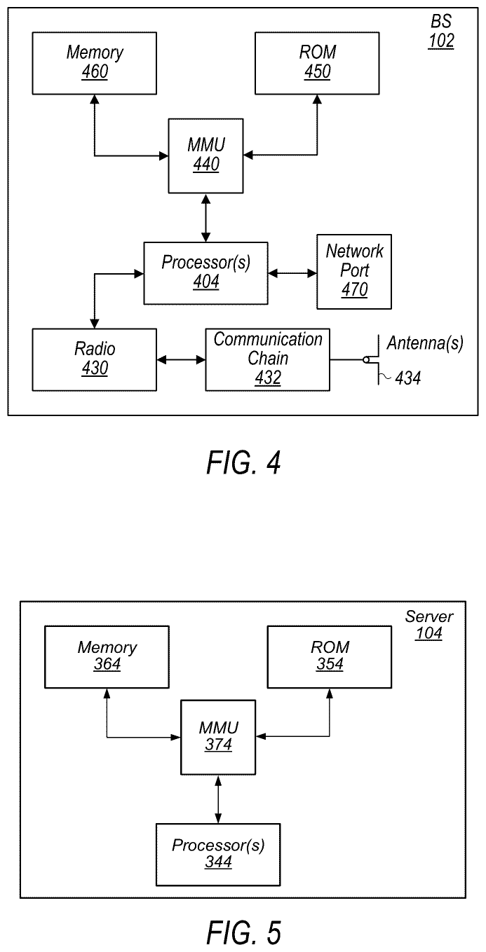

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, NR, LTE, LTE-A WCDMA, CDMA2000, etc. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may also be designed as an access point (AP), in which case network port 470 may be implemented to provide access to a wide area network and/or local area network(s), e.g., it may include at least one Ethernet port, and radio 430 may be designed to communicate according to the Wi-Fi standard. The base station 102 may operate according to the various methods as disclosed herein.

### FIG. 5: Block Diagram of a Server

FIG. 5 illustrates an example block diagram of a server 104, according to some embodiments. It is noted that the server of FIG. 5 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

### User Consent Framework

In current implementations, a network (e.g., a base station of a network) may request that a UE provide location information (e.g., Global Navigation Satellite System (GNSS) based location) by including an indication to obtain the UE's location information in a radio resource control (RRC) parameter, such as in an RRCReconfiguration parameter. Once configured, the UE may provide available detailed location information in a measurement report, a radio link failure (RLF) report, a connection establishment failure (CEF) report, and/or in a secondary cell group failure information parameter, such as an SCGFailureInformation parameter. Note that the request for location information may be for network optimization as opposed to being used for commercial or public safety purposes. However, there is some concern that in certain jurisdictions, an operator may be required to obtain user consent for location information sharing which is not allowed by current 3GPP specifications. Further, there ongoing work in standards development to define user consent requirements.

Embodiments described herein provide systems, methods, and mechanisms for a framework for user consent delivery and utilization in cellular communication systems. Note that embodiments described herein are unrelated to collection of user consent for sharing various information, e.g., such as collection of user consent for sharing radio link failure information and/or user location information, which may be used by a network operator for various purposes, e.g., such as network optimization. In other words, embodiments described herein are related to sharing of user consent information within a cellular communication system (e.g., between various nodes and/or entities within and/or in communication with the cellular communication system) and are not related to collection of user consent information and/or collection of various information based on user consent information. In some instances, the user consent may be to allow/disallow sharing of radio link failures and/or location information, among other functionalities. In some instances, user consent information may be stored in UE subscription information in a User Data Management (UDM) that may manage network user data in a centralized element (e.g., a centralized server). In some instances, various portions of current standards may be changed to support user consent information delivery and utilization, e.g., between an AMF and a base station. In particular, various interfaces may be modified to allow delivery and utilization of user consent information as well as revocation of user consent from the UDM to various points within a network. For example, a UDM service-based interface (Nudm) as defined by 3PGG TS 29.503 may be modified to allow an AMF to access information in the UDM. Note that Nudm identifies a service-based interface for the UDM. As another example, a Next Generation (NG) Application Protocol (NG-AP) as defined by 3GPP TS 38.413 may be modified to allow an AMF to propagate information retrieved from the UDM to a base station. Note that an NG-AP may provide control plane signaling between a base station (e.g., an NR-RAN node) and the AMF. As a further example, an Xn Application Protocol (Xn-AP) as defined in 3GPP TS 38.423 may be modified to allow a source base station to propagate information retrieved from the UDM to a target base station. Note that an Xn-AP is a control protocol used between base stations to support a variety of RAN related procedures, including establishment of Dual Connectivity, coordination of Xn based handovers, data forwarding, and/or RAN Paging. In some instances, a base station may only request a UE to provide detailed user location information, including in an RRCReconfiguration the OtherConfig IE with obtainCommonLocation set to true, if and/or when the base station has received user consent to collect such information. Note that when and/or if user consent is revoked, an AMF may also notify a base station (e.g., serving and/or target base station) so that the base station may halt processing and collecting UE location information. As noted above, the user consent revocation notification may use the interfaces described above for user consent delivery and utilization (e.g., Nudm, NG-AP, and/or Xn-AP).

In some instances, a UDM may be paired with a user data repository (UDR) that may store user data such as user consent information, user profile information, user authentication information, and/or encryption keys for the information. The UDM may reside on a control plane and may utilize microservices to communicate between a user plane and the control plane. In such instances, the UDM may be considered a stateless UDM. In other instances, when user data is stored locally on a UDM, the UDM may be considered a stateful UDM.

In some instances, user consent may be required for 3GPP features depending on local regulations. Further, user consent is obtained from an end-user, thus, user consent is tied to subscription information associated with the end-user. However, how authorization is provided between the subscriber and the end-user is out-of-scope of 3GPP as well as this disclosure.

In some instances, a UDM may provide support services related to the user consent information, such as retrieval of user consent parameters and/or notification of changes to user consent parameters. User consent parameters may be stored in a UDM/UDR as subscription data. In some instances, user consent parameters may be bound to a Subscriber Permanent Identifier (SUPI) and/or to a Generic Public Subscription Identifier (GPSI). Note that a SUPI is a 5G globally unique identifier allocated to each subscriber and defined in 3GPP TS 23.501. The SUPI value may be provisioned in a USIM and UDM/UDR in a 5G core (5GC). Note further that the SUPI may be encrypted and transmitted over air as a Subscriber Concealed Identifier (SUCI). Note that a GPSI may be used for addressing a 3GPP subscription in different networks outside of a 3GPP system. GPSIs may be public identifiers such as a Mobile Station International Integrated Services Digital Network number (MSISDN) or an External Identifier. An MSISDN is a standard international telephone number used to identify a give subscriber.

In some instances, user consent parameters may be bound to a single purpose of data processing. The user consent parameters may include whether the user consent is granted or not. Additionally, the user consent parameters may be effective only after a point in time that user consent was given. Further, user consent parameters may remain in effect until revoked. In other words, user consent parameters do not expire nor is there a validity timer associated to the user consent parameters.

In some instances, user consent information may include user consent parameters such as a parameter indicating UE ID, e.g., SUPI and/or GPSI, a parameter indicated a purpose of data processing, and/or a parameter indicated a status of user consent, e.g., granted and/or revoked. In some instances, user consent information may also include a public land mobile network (PLMN) list for each UE ID, location granularity, and/or other information. In some instances, user consent may be granted and/or revoked for specific PLMNs. For example, user consent may be granted for a first PLMN but not a second PLMN in the PLMN list. As another example, user consent may be granted for one or more PLMNs in the PLMN list and revoked for one or more other PLMNs in the PLMN list. As a further example, user consent may not yet be specified for one or more PLMNs in the PLMN list, e.g., neither granted nor revoked.

In some instances, e.g., as described above, an AMF, which may be a server 104 as described herein, may obtain user consent information from a UDM, which may also be a server 104 as described herein and/or be paired with a UDR which may also be a server 104 as described herein. For example, the AMF may obtain user consent information from the UDM via (and/or using) a Nudm service such as a Nudm_SubscriberDataManagement service. The AMF, for example, may use a “get” service operation and an Access and Mobility Subscription Data Retrieval procedure as defined by clause 5.2.2.3 of 3GPP TS 29.503. In some instances, a structured data type AccessAndMobilitySubscriptionData may be modified as illustrated by Tables 1A-1H.

For example, as illustrated by Tables 1A and 1B, a user consent PLMN list parameter (e.g., information element) may be added to a structured data type AccessAndMobilitySubscriptionData. The user consent PLMN list parameter may be an array data type. The user consent PLMN list parameter may include PLMN identifiers (PLMN IDs) corresponding to PLMNs that have obtained user consent for sharing of various user information, e.g., such as general location sharing (e.g., via an RLF report and/or a CEF report), RLF report information sharing, and/or CEF report information sharing. In other words, the user consent PLMN list parameter may include PLMN IDs associated with PLMNs that have obtained user consent to collect various user information for network purposes, such as network optimization. In some instances, the user consent PLMN list parameter may be an optional element in the structured data type AccessAndMobilitySubscriptionData (e.g., as shown in Table 1A). Thus, omission of the user consent PLMN list parameter may indicate that user consent has not been obtained for any PLMN associated with a user. In other instances, the user consent PLMN list parameter may be a mandatory element in the structured data type AccessAndMobilitySubscriptionData (e.g., as shown in Table 1B).

TABLE 1A

| Attribute Name | Data Type | Presence | Cardinality |
|---|---|---|---|
| supportedFeatures | Supported Features | Optional | 0 . . . 1 |
| Gpsis | Array(Gpsi) | Optional | 0 . . . N |
| internalGroupIds | Array(GroupID) | Optional | 0 . . . N |

. . .

| | | | |
|---|---|---|---|
| userConsentPlmnList | Array(PlmnId) | Optional | 0 . . . 1 |

TABLE 1B

| Attribute Name | Data Type | Presence | Cardinality |
|---|---|---|---|
| supportedFeatures | Supported Features | Optional | 0 . . . 1 |
| Gpsis | Array(Gpsi) | Optional | 0 . . . N |
| internalGroupIds | Array(GroupID) | Optional | 0 . . . N |

. . .

| | | | |
|---|---|---|---|
| userConsentPlmnList | Array(PlmnId) | Mandatory | 0 . . . 1 |

As another example, as illustrated by Tables 1C and 1D, a user consent PLMN array parameter (e.g., information element) may be added to a structured data type AccessAndMobilitySubscriptionData. The user consent PLMN array parameter may be an array data type. The user consent PLMN array parameter may include PLMN identifiers (PLMN IDs) corresponding to PLMNs that have obtained user consent for sharing of various user information, e.g., such as general location sharing (e.g., via an RLF report and/or a CEF report), RLF report information sharing, and/or CEF report information sharing, as well as an associated data type. In other words, the user consent PLMN array parameter may include PLMN IDs associated with PLMNs that have obtained user consent to collect various user information for network purposes, such as network optimization, as well as data types the user has consented to sharing. In some instances, the user consent PLMN array parameter may be an optional element in the structured data type AccessAndMobilitySubscriptionData (e.g., as shown in Table 1C). Thus, omission of the user consent PLMN array parameter may indicate that user consent has not been obtained for any PLMN associated with a user. In other instances, the user consent PLMN list parameter may be a mandatory element in the structured data type AccessAndMobilitySubscriptionData (e.g., as shown in Table 1D).

TABLE 1C

| Attribute Name | Data Type | Presence | Cardinality |
|---|---|---|---|
| supportedFeatures | Supported Features | Optional | 0 . . . 1 |
| Gpsis | Array(Gpsi) | Optional | 0 . . . N |
| internalGroupIds | Array(GroupID) | Optional | 0 . . . N |

. . .

| | | | |
|---|---|---|---|
| userConsentPlmnArray | Array(PlmnId, Type) | Optional | 0 . . . 1 |

TABLE 1D

| Attribute Name | Data Type | Presence | Cardinality |
|---|---|---|---|
| supportedFeatures | Supported Features | Optional | 0 . . . 1 |
| Gpsis | Array(Gpsi) | Optional | 0 . . . N |
| internalGroupIds | Array(GroupID) | Optional | 0 . . . N |

. . .

| | | | |
|---|---|---|---|
| userConsentPlmnArray | Array(PlmnId, Type) | Mandatory | 0 . . . 1 |

As a further example, as illustrated by Tables 1E and 1F, a user location sharing PLMN list parameter (e.g., information element) may be added to a structured data type AccessAndMobilitySubscriptionData. The user location sharing PLMN list parameter may be an array data type. The user location sharing PLMN list parameter may include PLMN identifiers (PLMN IDs) corresponding to PLMNs that have obtained user consent for sharing of the user's location. In other words, the user location sharing PLMN list parameter may include PLMN IDs associated with PLMNs that have obtained user consent to collect user location for network purposes, such as network optimization. In some instances, the user location sharing PLMN list parameter may be an optional element in the structured data type AccessAndMobilitySubscriptionData (e.g., as shown in Table 1E). Thus, omission of the user location sharing PLMN list parameter may indicate that user consent has not been obtained for any PLMN associated with a user. In other instances, the user location sharing PLMN list parameter may be a mandatory element in the structured data type AccessAndMobilitySubscriptionData (e.g., as shown in Table 1F).

TABLE 1E

| Attribute Name | Data Type | Presence | Cardinality |
|---|---|---|---|
| supportedFeatures | Supported Features | Optional | 0 . . . 1 |
| Gpsis | Array(Gpsi) | Optional | 0 . . . N |
| internalGroupIds | Array(GroupID) | Optional | 0 . . . N |

. . .

| | | | |
|---|---|---|---|
| userLocationSharingPlmnList | Array(PlmnId) | Optional | 0 . . . 1 |

TABLE 1F

| Attribute Name | Data Type | Presence | Cardinality |
|---|---|---|---|
| supportedFeatures | Supported Features | Optional | 0 . . . 1 |
| Gpsis | Array(Gpsi) | Optional | 0 . . . N |
| internalGroupIds | Array(GroupID) | Optional | 0 . . . N |

. . .

| | | | |
|---|---|---|---|
| userLocationSharingPlmnList | Array(PlmnId) | Mandatory | 0 . . . 1 |

As a yet further example, as illustrated by Tables 1G and 1H, a user location sharing allowed parameter (e.g., information element) may be added to a structured data type AccessAndMobilitySubscriptionData. The user location sharing allowed parameter may be a Boolean data type. The user location sharing allowed parameter may indicate whether user consent for sharing of the user's location has been obtained. In other words, the user location sharing allowed parameter may indicate that user consent has been obtained for collecting user location for network purposes, such as network optimization. In some instances, the user location sharing allowed parameter may be an optional element in the structured data type AccessAndMobilitySubscriptionData (e.g., as shown in Table 1G). Thus, omission of the user location sharing allowed parameter may indicate that user consent has not been obtained for a user. In other instances, the user location sharing allowed parameter may be a mandatory element in the structured data type AccessAndMobilitySubscriptionData (e.g., as shown in Table 1H). Note that in some instances, the location information sharing allowed parameter may be a Boolean value set to True or False. In some instances, the location information sharing allowed parameter may be encoded as an enumerated value, e.g., such as Allowed, Not Allowed, Revoked, and so forth.

TABLE 1G

| Attribute Name | Data Type | Presence | Cardinality |
|---|---|---|---|
| supportedFeatures | Supported Features | Optional | 0 . . . 1 |
| Gpsis | Array(Gpsi) | Optional | 0 . . . N |
| internalGroupIds | Array(GroupID) | Optional | 0 . . . N |

. . .

| | | | |
|---|---|---|---|
| userLocationSharingAllowed | Boolean | Optional | 0 . . . 1 |

TABLE 1H

| Attribute Name | Data Type | Presence | Cardinality |
|---|---|---|---|
| supportedFeatures | Supported Features | Optional | 0 . . . 1 |
| Gpsis | Array(Gpsi) | Optional | 0 . . . N |
| internalGroupIds | Array(GroupID) | Optional | 0 . . . N |

. . .

| | | | |
|---|---|---|---|
| userLocationSharingAllowed | Boolean | Mandatory | 0 . . . 1 |

In some instances, the AMF may use a Nudm_SubscriberDataManagement service parameter (e.g., information element) and/or a Nudm_ParameterProvision service parameter (e.g., information element) to revoke user consent. For example, the AMF may use a subscribe service operation for subscription to a notification of a data change (e.g., individual/shared) in the UDM and an unsubscribe service operation to unsubscribe to a notification of data change. In addition, the AMF may use a notification service operation and data change notification to NF procedure to be notified about subscription data change in UDM. Further, changes to subscription information in the UDM may be accomplished through a Nudm_ParameterProvision service. The update service operation may be used with subscription data update procedure to change user consent. The NF may send a PATCH request in such instances. The changes may also apply to AccessAndMobilitySubscriptionData datatype.

In some instances, e.g., as described above, an AMF, which may be a server 104 as described herein, may provide user consent information to a base station, such as base station 102. In some instances, the AMF may use an NG-AP message such as an initial context setup request message (e.g., as shown in Tables 2A-2H), a UE context modification request message (e.g., as shown in Tables 3A-3H), and/or a handover request message (e.g., as shown in Tables 4A-4H) to provide user consent information to the base station. The user consent information may be included in any of these messages via a parameter (e.g., information element) as illustrated by Tables 5A-5D.

For example, as illustrated by Tables 2A and 2B, an NG-AP message such as an initial context setup request message may include a user consent sharing PLMN list information element, e.g., as further described in reference to Table 5A, to indicate user consent information. The user consent sharing PLMN list information element may be optional (Table 2A) or mandatory (Table 2B).

TABLE 2A

| IE/Group Name | Presence | |
|---|---|---|
| Message Type | Mandatory | . . . |
| AMF UE NGAP ID | Mandatory | |
| RAN UE NGAP ID | Mandatory | |

. . .

| | | |
|---|---|---|
| Management Based MDT PLMN List | Optional | . . . |
| UE Radio Capability ID | Optional | |
| User Consent Sharing PLMN List | Optional | |

TABLE 2B

| IE/Group Name | Presence | |
|---|---|---|
| Message Type | Mandatory | . . . |
| AMF UE NGAP ID | Mandatory | |
| RAN UE NGAP ID | Mandatory | |

. . .

| | | |
|---|---|---|
| Management Based MDT PLMN List | Optional | . . . |
| UE Radio Capability ID | Optional | |
| User Consent Sharing PLMN List | Mandatory | |

As another example, as illustrated by Tables 2C and 2D, an NG-AP message such as an initial context setup request message may include a user consent sharing PLMN array information element, e.g., as further described in reference to Table 5B, to indicate user consent information. The user consent sharing PLMN array information element may be optional (Table 2C) or mandatory (Table 2D).

TABLE 2C

| IE/Group Name | Presence | |
|---|---|---|
| Message Type | Mandatory | . . . |
| AMF UE NGAP ID | Mandatory | |
| RAN UE NGAP ID | Mandatory | |

. . .

| | | |
|---|---|---|
| Management Based MDT PLMN List | Optional | . . . |
| UE Radio Capability ID | Optional | |
| User Consent Sharing PLMN Array | Optional | |

TABLE 2D

| IE/Group Name | Presence | |
|---|---|---|
| Message Type | Mandatory | . . . |
| AMF UE NGAP ID | Mandatory | |
| RAN UE NGAP ID | Mandatory | |

. . .

| | | |
|---|---|---|
| Management Based MDT PLMN List | Optional | . . . |
| UE Radio Capability ID | Optional | |
| User Consent Sharing PLMN Array | Mandatory | |

As a further example, as illustrated by Tables 2E and 2F, an NG-AP message such as an initial context setup request message may include a user location sharing PLMN list information element, e.g., as further described in reference to Table 5C, to indicate user consent information associated with location sharing. The user location sharing PLMN list information element may be optional (Table 2E) or mandatory (Table 2F).

TABLE 2E

| IE/Group Name | Presence | |
|---|---|---|
| Message Type | Mandatory | . . . |
| AMF UE NGAP ID | Mandatory | |
| RAN UE NGAP ID | Mandatory | |

. . .

| | | |
|---|---|---|
| Management Based MDT PLMN List | Optional | . . . |
| UE Radio Capability ID | Optional | |
| User Location Sharing PLMN List | Optional | |

TABLE 2F

| IE/Group Name | Presence | |
|---|---|---|
| Message Type | Mandatory | . . . |
| AMF UE NGAP ID | Mandatory | |
| RAN UE NGAP ID | Mandatory | |

. . .

| | | |
|---|---|---|
| Management Based MDT PLMN List | Optional | . . . |
| UE Radio Capability ID | Optional | |
| User Location Sharing PLMN List | Mandatory | |

As a yet further example, as illustrated by Tables 2G and 2H, an NG-AP message such as an initial context setup request message may include management based a user location sharing allowed information element, e.g., as further described in reference to Table 5D, to indicate user consent information associated with location sharing. The user location sharing allowed information element may be optional (Table 2G) or mandatory (Table 2H).

TABLE 2G

| IE/Group Name | Presence | |
|---|---|---|
| Message Type | Mandatory | . . . |
| AMF UE NGAP ID | Mandatory | |
| RAN UE NGAP ID | Mandatory | |

. . .

| | | |
|---|---|---|
| Management Based MDT PLMN List | Optional | . . . |
| UE Radio Capability ID | Optional | |
| User Location Sharing Allowed | Optional | |

TABLE 2H

| IE/Group Name | Presence | |
|---|---|---|
| Message Type | Mandatory | . . . |
| AMF UE NGAP ID | Mandatory | |
| RAN UE NGAP ID | Mandatory | |

. . .

| | | |
|---|---|---|
| Management Based MDT PLMN List | Optional | . . . |
| UE Radio Capability ID | Optional | |
| User Location Sharing Allowed | Mandatory | |

As another example, as illustrated by Tables 3A and 3B, an NG-AP message such as a UE context modification request message may include a user consent sharing PLMN list information element, e.g., as further described in reference to Table 5A, to indicate user consent information. The user consent sharing PLMN list information element may be optional (Table 3A) or mandatory (Table 3B).

TABLE 3A

| IE/Group Name | Presence | |
|---|---|---|
| Message Type | Mandatory | . . . |
| AMF UE NGAP ID | Mandatory | |
| RAN UE NGAP ID | Mandatory | |

. . .

| | |
|---|---|
| User Consent Sharing PLMN List | Optional |

TABLE 3B

| IE/Group Name | Presence | |
|---|---|---|
| Message Type | Mandatory | . . . |
| AMF UE NGAP ID | Mandatory | |
| RAN UE NGAP ID | Mandatory | |

. . .

| | |
|---|---|
| User Consent Sharing PLMN List | Mandatory |

As another example, as illustrated by Tables 3C and 3D, an NG-AP message such as a UE context modification request message may include a user consent sharing PLMN array information element, e.g., as further described in reference to Table 5B, to indicate user consent information. The user consent sharing PLMN array information element may be optional (Table 3C) or mandatory (Table 3D).

TABLE 3C

| IE/Group Name | Presence | |
|---|---|---|
| Message Type | Mandatory | . . . |
| AMF UE NGAP ID | Mandatory | |
| RAN UE NGAP ID | Mandatory | |

. . .

| | |
|---|---|
| User Consent Sharing PLMN Array | Optional |

TABLE 3D

| IE/Group Name | Presence | |
|---|---|---|
| Message Type | Mandatory | . . . |
| AMF UE NGAP ID | Mandatory | |
| RAN UE NGAP ID | Mandatory | |

. . .

| | |
|---|---|
| User Consent Sharing PLMN Array | Mandatory |

As a further example, as illustrated by Tables 3E and 3F, an NG-AP message such as a UE context modification request message may include a user location sharing PLMN list information element, e.g., as further described in reference to Table 5C, to indicate user consent information associated with location sharing. The user location sharing PLMN list information element may be optional (Table 3E) or mandatory (Table 3F).

TABLE 3E

| IE/Group Name | Presence | |
|---|---|---|
| Message Type | Mandatory | . . . |
| AMF UE NGAP ID | Mandatory | |
| RAN UE NGAP ID | Mandatory | |

. . .

| | |
|---|---|
| User Location Sharing PLMN List | Optional |

TABLE 3F

| IE/Group Name | Presence | |
|---|---|---|
| Message Type | Mandatory | . . . |
| AMF UE NGAP ID | Mandatory | |
| RAN UE NGAP ID | Mandatory | |

. . .

| | |
|---|---|
| User Location Sharing PLMN List | Mandatory |

As a yet further example, as illustrated by Tables 3G and 3H, an NG-AP message such as a UE context modification request message may include management based a user location sharing allowed information element, e.g., as further described in reference to Table 5D, to indicate user consent information associated with location sharing. The user location sharing allowed information element may be optional (Table 3G) or mandatory (Table 3H).

TABLE 3G

| IE/Group Name | Presence | |
|---|---|---|
| Message Type | Mandatory | . . . |
| AMF UE NGAP ID | Mandatory | |
| RAN UE NGAP ID | Mandatory | |

. . .

| | |
|---|---|
| User Location Sharing Allowed | Optional |

TABLE 3H

| IE/Group Name | Presence | |
|---|---|---|
| Message Type | Mandatory | . . . |
| AMF UE NGAP ID | Mandatory | |
| RAN UE NGAP ID | Mandatory | |

. . .

| | |
|---|---|
| User Location Sharing Allowed | Mandatory |

As a further another example, as illustrated by Tables 4A and 4B, an NG-AP message such as a handover request message may include a user consent sharing PLMN list information element, e.g., as further described in reference to Table 5A, to indicate user consent information. The user consent sharing PLMN list information element may be optional (Table 4A) or mandatory (Table 4B).

TABLE 4A

| IE/Group Name | Presence | |
|---|---|---|
| Message Type | Mandatory | . . . |
| AMF UE NGAP ID | Mandatory | |
| RAN UE NGAP ID | Mandatory | |
| Handover Type | Mandatory | |
| Cause | Mandatory | |

. . .

| | | |
|---|---|---|
| User Consent Sharing PLMN List | Optional | . . . |

TABLE 4B

| IE/Group Name | Presence | |
|---|---|---|
| Message Type | Mandatory | . . . |
| AMF UE NGAP ID | Mandatory | |
| RAN UE NGAP ID | Mandatory | |
| Handover Type | Mandatory | |
| Cause | Mandatory | |

. . .

| | | |
|---|---|---|
| User Consent Sharing PLMN List | Mandatory | . . . |

As another example, as illustrated by Tables 4C and 4D, an NG-AP message such as a handover request message may include a user consent sharing PLMN array information element, e.g., as further described in reference to Table 5B, to indicate user consent information. The user consent sharing PLMN array information element may be optional (Table 4C) or mandatory (Table 4D).

TABLE 4C

| IE/Group Name | Presence | |
|---|---|---|
| Message Type | Mandatory | . . . |
| AMF UE NGAP ID | Mandatory | |
| RAN UE NGAP ID | Mandatory | |
| Handover Type | Mandatory | |
| Cause | Mandatory | |

. . .

| | | |
|---|---|---|
| User Consent Sharing PLMN Array | Optional | . . . |

TABLE 4D

| IE/Group Name | Presence | |
|---|---|---|
| Message Type | Mandatory | . . . |
| AMF UE NGAP ID | Mandatory | |
| RAN UE NGAP ID | Mandatory | |
| Handover Type | Mandatory | |
| Cause | Mandatory | |

. . .

| | | |
|---|---|---|
| User Consent Sharing PLMN Array | Mandatory | . . . |

As a further example, as illustrated by Tables 4E and 4F, an NG-AP message such as a handover request message may include a user location sharing PLMN list information element, e.g., as further described in reference to Table 5C, to indicate user consent information associated with location sharing. The user location sharing PLMN list information element may be optional (Table 4E) or mandatory (Table 4F).

TABLE 4E

| IE/Group Name | Presence | |
|---|---|---|
| Message Type | Mandatory | . . . |
| AMF UE NGAP ID | Mandatory | |
| RAN UE NGAP ID | Mandatory | |
| Handover Type | Mandatory | |
| Cause | Mandatory | |

. . .

| | | |
|---|---|---|
| User Location Sharing PLMN List | Optional | . . . |

TABLE 4F

| IE/Group Name | Presence | |
|---|---|---|
| Message Type | Mandatory | . . . |
| AMF UE NGAP ID | Mandatory | |
| RAN UE NGAP ID | Mandatory | |
| Handover Type | Mandatory | |
| Cause | Mandatory | |

. . .

| | | |
|---|---|---|
| User Location Sharing PLMN List | Mandatory | . . . |

As a yet further example, as illustrated by Tables 4G and 4H, an NG-AP message such as a handover request message may include management based a user location sharing allowed information element, e.g., as further described in reference to Table 5D, to indicate user consent information associated with location sharing. The user location sharing allowed information element may be optional (Table 4G) or mandatory (Table 4H).

TABLE 4G

| IE/Group Name | Presence | |
|---|---|---|
| Message Type | Mandatory | . . . |
| AMF UE NGAP ID | Mandatory | |
| RAN UE NGAP ID | Mandatory | |
| Handover Type | Mandatory | |
| Cause | Mandatory | |

. . .

| | | |
|---|---|---|
| User Location Sharing Allowed | Optional | . . . |

TABLE 4H

| IE/Group Name | Presence | |
|---|---|---|
| Message Type | Mandatory | . . . |
| AMF UE NGAP ID | Mandatory | |
| RAN UE NGAP ID | Mandatory | |
| Handover Type | Mandatory | |
| Cause | Mandatory | |

. . .

| | | |
|---|---|---|
| User Location Sharing Allowed | Mandatory | . . . |

As illustrated by Table 5A, a user consent sharing PLMN list information element may include a PLMN identity information element with a type of PLMN Identity as defined by 3GPP specifications. A range of the PLMN identity information element may be from 1 to a maximum number of PLMNs, where the maximum number of PLMNs may be specified, e.g., by a 3GPP specification, by a network operator, and/or by a UE manufacturer. The user consent PLMN list information element may include PLMN identifiers (PLMN IDs) corresponding to PLMNs that have obtained user consent for sharing of various user information, e.g., such as general location sharing (e.g., via an RLF report and/or a CEF report), RLF report information sharing, and/or CEF report information sharing. In other words, the user consent PLMN list information element may include PLMN IDs associated with PLMNs that have obtained user consent to collect various user information for network purposes, such as network optimization.

TABLE 5A

| IE/Group Name | Presence | Range | IE Type |
|---|---|---|---|
| User Consent | | 1 . . . <maxnoofPLMNs> | |
| Sharing PLMN List | | | |
| >PLMN Identity | Mandatory | | PLMN |
| | | | Identity |

As illustrated by Table 5B, a user consent sharing PLMN array information element may include a PLMN identity information element with a type of PLMN Identity as defined by 3GPP specifications as well as a type information element. A range of the PLMN identity information element may be from 1 to a maximum number of PLMNs, where the maximum number of PLMNs may be specified, e.g., by a 3GPP specification, by a network operator, and/or by a UE manufacturer. The user consent PLMN array information element may include PLMN identifiers (PLMN IDs) corresponding to PLMNs that have obtained user consent for sharing of various user information, e.g., such as general location sharing (e.g., via an RLF report and/or a CEF report), RLF report information sharing, and/or CEF report information sharing. The type information element may indicate a type of information sharing consented to, e.g., such as general location sharing (e.g., via an RLF report and/or a CEF report), RLF report information sharing, and/or CEF report information sharing. In other words, the user consent PLMN list information element may include PLMN IDs associated with PLMNs that have obtained user consent to collect various user information for network purposes, such as network optimization and the type information element may indicate a type of data shared.

TABLE 5B

| IE/Group Name | Presence | Range | IE Type |
|---|---|---|---|
| User Consent | | (1 . . . <maxnoofPLMNs>, | |
| Sharing PLMN Array | | 1 . . . <Types>) | |
| >PLMN Identity | Mandatory | | PLMN |
| | | | Identity |
| >Type | Mandatory | | |

As illustrated by Table 5C, a user location sharing PLMN list information element may include PLMN identifiers (PLMN IDs) corresponding to PLMNs that have obtained user consent for sharing of various user information, e.g., such as general location sharing (e.g., via an RLF report and/or a CEF report), RLF report information sharing, and/or CEF report information sharing. A range of the PLMN identity information element may be from 1 to a maximum number of PLMNs, where the maximum number of PLMNs may be specified, e.g., by a 3GPP specification, by a network operator, and/or by a UE manufacturer. The user location sharing PLMN list information element may include PLMN identifiers (PLMN IDs) corresponding to PLMNs that have obtained user consent for sharing of various user information, e.g., such as general location sharing (e.g., via an RLF report and/or a CEF report), RLF report information sharing, and/or CEF report information sharing. In other words, the user consent PLMN list information element may include PLMN IDs associated with PLMNs that have obtained user consent to collect various user information for network purposes, such as network optimization.

TABLE 5C

| IE/Group Name | Presence | Range | IE Type |
|---|---|---|---|
| User Location | | 1 . . . <maxnoofPLMNs> | |
| Sharing PLMN List | | | |
| >PLMN Identity | Mandatory | | PLMN |
| | | | Identity |

As illustrated by Table 5D, a user location sharing allowed information element may be encoded as an enumerated value, e.g., such as Allowed, Not Allowed, Revoked, and so forth. In some instances, the user location information sharing allowed information element may be a Boolean value in which a value of 1 or “True” indicates user consent and a value of 0 or “False” indicates no user consent.

TABLE 5D

| | | | |
|---|---|---|---|
| IE/Group Name | Presence | Range | IE Type |

| | | |
|---|---|---|
| User Consent Sharing Allowed | Mandatory | Enumerated |

In some instances, e.g., as described above, user consent information may need to be propagated via an Xn-AP interface from a source base station, such as base station 102, to a target base station, such as another base station 102. In some instances, the base station may use a message such as a handover request message (e.g., as shown in Tables 4A-4H) or a retrieve UE context response message to provide user consent to the target base station. The user consent information may be included in any of these messages via an information element as described above in reference to Table 5A-5D.

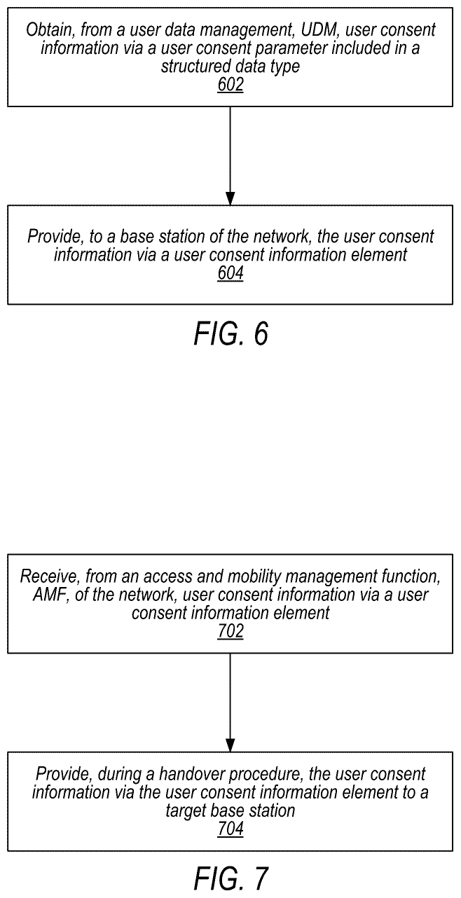

FIG. 6 illustrates a block diagram of an example of a method for delivery and utilization of user consent information within a network, according to some embodiments. The method shown in FIG. 6 may be used in conjunction with any of the systems, methods, or devices shown in the Tables and Figures, among other devices. In various embodiments, some of the method elements shown may be performed concurrently, in a different order than shown, or may be omitted. Additional method elements may also be performed as desired. As shown, this method may operate as follows.

At 602, an AMF of a network, which may be a server 104, may obtain, from a user data management (UDM), user consent information via a user consent parameter included in a structured data type. The structured data type may be an AccessAndMobilitySubscriptionData. The user consent parameter may be associated with at least one data type. The at least one data type may include any, any combination of, and or all of (e.g., one or more of and/or at least one of) general user location information sharing consent (e.g., via radio link failure (RLF) report information sharing consent and/or connection establishment failure (CEF) report information sharing consent), RLF report information sharing consent, and/or CEF report information sharing consent.

In some instances, the user consent information parameter may be a one-dimensional array of values. Each element of the one-dimensional array of values may be associated with a Public Land Mobile Network (PLMN) identifier. Additionally, the user consent information may be per PLMN.

In some instances, the user consent information parameter may be a Boolean value. In some instances, the user consent information parameter may be an Enumerated value.

In some instances, the user consent information parameter may be a two-dimensional array of values. A first dimension of the two-dimensional array of values may be associated with a Public Land Mobile Network (PLMN) identifier. Additionally, a second dimension of the two-dimensional array of values may be associated with a type of information. The type of information may include any, any combination of, and/or all of (e.g., at least one of and/or one or more of) general user location information sharing consent (e.g., via radio link failure (RLF) report information sharing consent and/or connection establishment failure (CEF) report information sharing consent), RLF report information sharing consent, and/or CEF report information sharing consent.

At 604, the AMF may provide, to a base station, such as base station 102, of the network, the user consent information via a user consent information element. The user consent information element may be associated with at least one data type. The at least one data type may include any, any combination of, and/or all of (e.g., one or more of and/or at least one of) general user location information sharing consent (e.g., via radio link failure (RLF) report information sharing consent and/or connection establishment failure (CEF) report information sharing consent), RLF report information sharing consent, and/or CEF report information sharing consent.

In some instances, the user consent information element may be a one-dimensional array of values. In such instances, each element of the one-dimensional array of values may be associated with a Public Land Mobile Network (PLMN) identifier. The user consent information may be per PLMN.

In some instances, the user consent information element may be a Boolean value. In some instances, the user consent information element may be an Enumerated value.

In some instances, the user consent information element may be a two-dimensional array of values. A first dimension of the two-dimensional array of values may be associated with a Public Land Mobile Network (PLMN) identifier. A second dimension of the two-dimensional array of values may be associated with a type of information. The type of information may include any, any combination of, and/or all of (e.g., at least one of and/or one or more of) general user location information sharing consent (e.g., via radio link failure (RLF) report information sharing consent and/or connection establishment failure (CEF) report information sharing consent), RLF report information sharing consent, and/or CEF report information sharing consent.

In some instances, providing, to the base station of the network, the user consent information via the user consent information element may include providing the user consent information via an initial context setup request message sent to the base station of the network. The user consent information element may be included in the initial context setup request message. In some instances, providing, to the base station of the network, the user consent information via the user consent information element may include providing the user consent information via a user equipment (UE) context modification request message sent to the base station of the network. The user consent information element may be included in the UE context modification request message. In some instances, providing, to the base station of the network, the user consent information via the user consent information element may include providing the user consent information via a handover request message sent to the base station of the network. The user consent information element may be included in the handover request message.

In some instances, the AMF of the network may subscribe to a notification of data change in the UDM and receive, from the UDM, a notification of a data change indicating a change in user consent information. The AMF may provide, to the base station of the network, the change in user consent information via the user consent information element.

FIG. 7 illustrates a block diagram of another example of a method for delivery and utilization of user consent information within a network, according to some embodiments. The method shown in FIG. 7 may be used in conjunction with any of the systems, methods, or devices shown in the Tables and Figures, among other devices. In various embodiments, some of the method elements shown may be performed concurrently, in a different order than shown, or may be omitted. Additional method elements may also be performed as desired. As shown, this method may operate as follows.

At 702, a base station of a network, such as base station 102, may receive, from an access and mobility management function (AMF) of the network, user consent information via a user consent information element. In some instances, receiving, from the AMF of the network, user consent information via the user consent information element may include receiving, from the AMF of the network, the user consent information via an initial context setup request message. The user consent information element may be included in the initial context setup request message. In some instances, receiving, from the AMF of the network, user consent information via the user consent information element may include receiving, from the AMF of the network, the user consent information via a user equipment (UE) context modification request message. The user consent information element may be included in the UE context modification request message. In some instances, receiving, from the AMF of the network, user consent information via the user consent information element may include receiving, from the AMF of the network, the user consent information via a handover request message. The user consent information element may be included in the handover request message.

The user consent information element may be associated with at least one data type. The at least one data type may include any, any combination of, and/or all of (e.g., one or more of and/or at least one of) general user location information sharing consent (e.g., via radio link failure (RLF) report information sharing consent and/or connection establishment failure (CEF) report information sharing consent), RLF report information sharing consent, and/or CEF report information sharing consent.

In some instances, the user consent information element may be a one-dimensional array of values. Each element of the one-dimensional array of values may be associated with a Public Land Mobile Network (PLMN) identifier. The user consent information may be per PLMN.

In some instances, the user consent information element may be a Boolean value. In some instances, the user consent information element may be an Enumerated value.

In some instances, the user consent information element may be a two-dimensional array of values. A first dimension of the two-dimensional array of values may be associated with a Public Land Mobile Network (PLMN) identifier. A second dimension of the two-dimensional array of values may be associated with a type of information. The type of information may include any, any combination of, and/or all of (e.g., at least one of and/or one or more of) general user location information sharing consent (e.g., via radio link failure (RLF) report information sharing consent and/or connection establishment failure (CEF) report information sharing consent), RLF report information sharing consent, and/or CEF report information sharing consent.

At 704, the base station may provide, during a handover procedure, the user consent information via the user consent information element to a target base station. In some instances, providing, during the handover procedure, the user consent information via the user consent information element to the target base station may include providing the user consent information via a handover request message sent to the target base station. The user consent information element may be included in the handover request message. In some instances, when the handover procedure is associated with a conditional handover, radio resource control, RRC, connection establishment, or RRC connection re-establishment, providing, during the handover procedure, the user consent information via the user consent information element to the target base station may include providing the user consent information via a retrieve user equipment (UE) context response message sent to the target base station. The user consent information element may be included in the retrieve UE context response message.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for delivery of user consent information within a network, comprising:
an access and mobility management function (AMF) of the network,
obtaining, from a user data management (UDM) user consent information via a user consent parameter included in a structured data type; and
providing, to a base station of the network, the user consent information via a user consent information element.

2. The method of claim 1,
wherein the structured data type is an AccessAndMobilitySubscriptionData.

3. The method of claim 1,
wherein the user consent parameter is associated with at least one data type; and
wherein the at least one data type includes at least one of:
connection error failure (CEF) report information sharing consent;
radio link failure (RLF) report information sharing consent; or
user location information sharing consent.

4. The method of claim 1,
wherein the user consent parameter is a one-dimensional array of values; and
wherein each element of the one-dimensional array of values is associated with a Public Land Mobile Network (PLMN) identifier.

5. The method of claim 4,
wherein the user consent information is per Public Land Mobile Network (PLMN).

6. The method of claim 1,
wherein the user consent parameter is a Boolean value.

7. The method of claim 1,
wherein the user consent parameter is an Enumerated value.

8. The method of claim 1,
wherein the user consent parameter is a two-dimensional array of values;
wherein a first dimension of the two-dimensional array of values is associated with a Public Land Mobile Network (PLMN) identifier; and
wherein a second dimension of the two-dimensional array of values is associated with a type of information.

9. The method of claim 8,
wherein the type of information includes one or more of:
radio link failure (RLF) information sharing consent; or
user location information sharing consent.

10. An apparatus, comprising:
a memory; and
at least one processor in communication with the memory and configured to perform operations comprising:
obtaining, from a user data management (UDM) user consent information via a user consent parameter included in a structured data type; and
providing, to a base station of a network, the user consent information via a user consent information element.

11. The apparatus of claim 10,
wherein the user consent information element is associated with at least one data type; and
wherein the at least one data type includes at least one of:
connection error failure (CEF) report information sharing consent;
radio link failure (RLF) report information sharing consent; or
user location information sharing consent.

12. The apparatus of claim 10,
wherein the user consent information element is a one-dimensional array of values; and
wherein each element of the one-dimensional array of values is associated with a Public Land Mobile Network (PLMN) identifier.

13. The apparatus of claim 12,
wherein the user consent information is per Public Land Mobile Network (PLMN).

14. The apparatus of claim 10,
wherein the user consent information element is a Boolean value.

15. The apparatus of claim 10,
wherein the user consent information element is an Enumerated value.

16. The apparatus of claim 10,
wherein the user consent information element is a two-dimensional array of values;
wherein a first dimension of the two-dimensional array of values is associated with a Public Land Mobile Network (PLMN) identifier; and
wherein a second dimension of the two-dimensional array of values is associated with a type of information, and wherein the type of information includes one or more of:
connection error failure (CEF) report information sharing consent;
radio link failure (RLF) report information sharing consent; or
user location information sharing consent.

17. A non-transitory computer readable memory medium storing instructions executable by processing circuitry to perform operations comprising:
obtaining, from a user data management (UDM) user consent information via a user consent parameter included in a structured data type; and
providing, to a base station of a network, the user consent information via a user consent information element.

18. The non-transitory computer readable memory medium of claim 17,
wherein the instructions executable by the processing circuitry to perform operations comprising providing, to the base station of the network, the user consent information via the user consent information element further include instructions executable by the processing circuitry to perform operations comprising:
providing the user consent information via an initial context setup request message sent to the base station of the network, wherein the user consent information element is included in the initial context setup request message.

19. The non-transitory computer readable memory medium of claim 17,
wherein the instructions executable by the processing circuitry to perform operations comprising providing, to the base station of the network, the user consent information via the user consent information element further include instructions executable by the processing circuitry to perform operations comprising:
providing the user consent information via a user equipment, UE, context modification request message sent to the base station of the network, wherein the user consent information element is included in the UE context modification request message.

20. The non-transitory computer readable memory medium of claim 17,
wherein the instructions executable by the processing circuitry to perform operations comprising providing, to the base station of the network, the user consent information via the user consent information element further include instructions executable by the processing circuitry to perform operations comprising:
providing the user consent information via a handover request message sent to the base station of the network, wherein the user consent information element is included in the handover request message.
